(19) United States
(12) Patent Application Publication
(10) Pub. No.: US 2020/0224780 A1
(43) Pub. Date: Jul. 16, 2020

(54) A NON-RETURN VALVE

(71) Applicant: PUMP PAL PTY LTD, Southport, Queensland (AU)

(72) Inventor: Terence DAY, Southport, Queensland (AU)

(21) Appl. No.: 15/754,798

(22) PCT Filed: Aug. 24, 2016
(86) PCT No.: PCT/AU2016/050783

§ 371 Date: Feb. 23, 2018

(30) Foreign Application Priority Data
Aug. 24, 2015 (AU) 2015903405

(51) Int. Cl. F16K 15/03

(52) U.S. Cl. CPC F16K 15/033; E03F 7/04; F16K 15/031

(57) ABSTRACT

A non-return valve includes a cylindrical valve seat insert that defines a fluid passageway and a valve seat terminating the passageway. A valve closure includes a valve flap that is pivotal about a pivot region with respect to the valve seat between a closed condition in which a periphery of the valve flap operatively engages the valve seat to close the fluid passageway and an open condition in which fluid is permitted to flow through the passageway. A biasing mechanism is interposed between the valve flap and an internal surface of the insert to bias the valve flap into the closed condition, the biasing mechanism being configured and arranged with respect to the valve flap such that a level of bias is adjusted to facilitate movement of the valve flap into the open condition.

### FIELD

Various embodiments of a non-return valve are described herein.

### SUMMARY

Various embodiments of a non-return valve comprise

a cylindrical valve seat insert that defines a fluid passageway and a valve seat terminating the passageway; and

a valve closure that includes

a valve flap that is pivotal about a pivot region with respect to the valve seat between a closed condition in which a periphery of the valve flap operatively engages the valve seat to close the fluid passageway and an open condition in which fluid is permitted to flow through the passageway; and

a biasing mechanism that is interposed between the valve flap and an internal surface of the insert to bias the valve flap into the closed condition, the biasing mechanism being configured and arranged with respect to the valve flap such that a level of bias is adjusted to facilitate movement of the valve flap pivots into the open condition.

The periphery of the valve flap and the valve seat may define complementary nesting formations that nest together when the valve flap is in the closed condition such that corresponding portions of the nesting formations define the pivot region.

The nesting formation of the valve flap may be in the form of a peripheral ridge that extends inwardly and the nesting formation of the valve seat is in the form of a peripheral recess in which the ridge is received when the valve flap is in the closed condition.

The outer lip may extend radially inwardly from the valve seat to overhang the periphery of the valve flap when the valve flap is in the closed condition.

The outer lip may be of a suitable material and may be dimensioned so that the outer lip can deform as a result of backpressure upstream of the valve closure to enhance sealing of the valve flap to the valve seat.

The biasing mechanism may be configured so that the biasing mechanism can be displaced both pivotally and linearly with respect to the valve flap to adjust the level of bias.

The biasing mechanism may include an elongate, resiliently extendible member that is fixed, at one end, to the internal surface of the insert, and a catch that is fixed to an inner side of the valve flap, the catch defining an outwardly directed catch surface that is inwardly spaced from the inner side of the valve flap, an opposite end of the extendible member being engaged with the catch surface so that the opposite end of the extendible member can slide along the catch surface and towards the pivot region when the valve flap moves into the open condition and along the catch surface away from the pivot region when the valve flap moves into the closed condition.

The resiliently extendible member may be of an elastomeric material.

The catch may include a catch arm that is spaced from the inner side of the valve flap and extends from the pivot region towards a region diametrically opposed to the pivot region and that defines the catch surface.

Various embodiments of a non-return valve comprise

a cylindrical valve seat insert that defines a fluid passageway and a valve seat terminating the passageway, the insert including a valve closure retainer arranged on the valve seat; and

a valve closure that includes
a valve flap having an inner periphery that is operatively engageable with the valve seat; and
an anchor that is arranged on the valve flap and is anchored to the retainer so that the anchor can pivot with respect to the insert between an open condition in which the external surfaces of the insert and the valve flap are located in a common cylindrical area and a closed condition in which the valve flap bears against the valve seat; wherein

the anchor and the retainer are configured so that the anchor is constrained to a limited amount of linear movement relative to the retainer during pivotal movement between the open and closed conditions to facilitate sealing of the valve flap and the valve seat.

It will be appreciated that “settling” of a valve flap closure on a seat can improve sealing of the flap or closure on the seat. There may be a number of reasons for this. These can include manufacturing inconsistencies and variations in replacement parts, such as O-rings and other components that are used to facilitate sealing. For example, a new O-ring may extend from a valve closure to a greater extent than a previous O-ring. In such a case, restriction of the valve closure in a particular pivotal plane can result in improper sealing. Thus, the fact that the anchor can undergo a limited amount of linear movement relative to the retainer allows the valve flap to settle with respect to the valve seat.

The anchor may define a pivot formation. The valve closure retainer may define an aperture. The anchor may be dimensioned to extend through the aperture with the pivot formation located and retained at least partially externally of the valve seat.

The aperture may open externally into a recess defined by the retainer so that the pivot formation can pivot within the recess.

The retainer may include a pivot member at a front of the recess. The pivot formation may be shaped so that it can hook onto and pivot about the pivot member. The recess and the pivot formation may be dimensioned so that, when the valve flap is in the open condition, a gap is defined between the pivot formation and rear surfaces of the recess and the aperture to provide an extent of play of the valve closure with respect to the insert when the valve flap moves into the closed condition.

In use, the insert is positioned in a fluid conduit. The recess is located so that an internal surface of the fluid conduit serves to close the recess. The extent of play is such that, when the valve closure pivots into the closed condition, the valve closure is constrained to move linearly by the internal surface of the fluid conduit such that the pivot formation moves into a position in which it is retained in the recess. During such linear movement, the valve flap is permitted to settle on the valve seat.

An operatively internal surface of the pivot formation and the valve flap corresponds with a portion of the valve seat so that the pivot formation can nest with the valve flap.

The valve seat may include a proximal seat face and a distal seat face. In this specification, the proximal seat face may be interposed between the retainer and the distal seat face. The proximal seat face may transition to the distal seat face via a curved transition zone.

The proximal seat face and the distal seat face may lie in respective intersecting planes. The plane of the proximal seat face may be oriented at an angle of between 90 degrees and 135 degrees relative to an x-axis that is parallel to, and co-directional with, a line representing a direction of fluid flow through the insert. The plane of the distal seat face may be oriented at an angle of between 180 degrees and 225 degrees relative to the x-axis.

In one embodiment, the plane of the proximal seat face and the plane of the distal seat face may be symmetrical about a plane of the x-axis. Thus, in the closed condition, the valve flap may be orthogonal with respect to the x-axis.

The valve seat may be chamfered or tapered to define seat faces and edges of the valve seat that lie in the planes identified above. The valve flap may define chamfered or tapered peripheral faces that corresponds with the seat faces.

One of the inner periphery of the valve flap and the valve seat may be chamfered or tapered to define an edge and the other of the valve flap and the valve seat may be configured so that the edge can be embedded in said other of the valve flap and the valve seat.

The valve closure may include a support structure that is positioned on, or embedded in, a flexible body to provide structural integrity to the flexible body. The flexible body may be in the form of an elastomeric material, such as natural or artificial rubber. The support structure may be in the form of a relatively stiff material, compared to the material of the flexible body. The support structure may be in the form of a relatively rigid plastics material, for example. The support structure may be shaped to impart shape to the valve closure. The support structure may be embedded in the flexible body. The support structure may define openings to inhibit the delamination or separation of the body and the support structure.

The periphery of the valve closure may define a groove. A sealing element, such as an O-ring, may be secured or located in the groove so that, when the valve closure is in its closed condition, the groove can bear against the valve seat. It will be appreciated that the O-ring will extend partially from the periphery of the valve closure. The fact that the anchor is constrained to a limited amount of linear movement, as mentioned above, allows the valve closure to shift to accommodate the O-ring and to facilitate sealing.

The insert may have a two-part structure. A valve seat part that defines the valve seat may be in the form of a softer material than the remaining part of the insert. For example, the valve seat part can be of an elastomeric material, such as natural or synthetic rubber while the remaining part of the insert can be of a relatively harder plastics material, such as nylon, polyethylene, or polypropylene. In this embodiment, the valve closure may also be of a relatively harder plastics material that is capable of sealing against the valve seat of the softer material. As described above, with reference to the O-ring, the limited degree of linear movement of the anchor allows the valve closure to shift slightly to facilitate sealing between the valve closure and the valve seat.

The insert can be fitted into the conduit in a number of different ways according to different embodiments of a method.

In one embodiment, the insert may define a circumferentially extending recess or channel. In use, the recess or channel can be filled with a composition or compound that is configured to adhere to the internal surface of the fluid conduit, but not to the material of the insert. For example, when the insert is of rubber and the conduit is of a plastics material, selected adhesive or automotive body filler can be used as the composition or compound. It will be appreciated that the composition or compound thus serves as an internal flange to retain the insert in a conventional pipe without the need for making modifications to the pipe.

In another embodiment, the insert may define a series of annular serrations that are oriented so that the insert can be pushed into the conduit but inhibited from being withdrawn from the conduit. The material of the insert can be selected so that the serrations can dig into the conduit when an ejection pressure is exerted on the valve closure in the closed condition. The serrations can be discreet or can be arranged helically so that the insert can be screwed into the conduit.

The insert may define a flange. The flange may be positioned at an inlet end of the insert. Alternatively, the flange may be interposed between the inlet end and an outlet end of the insert. In this case, the flange can be secured between an end of the fluid conduit and an end of a connecting pipe that delivers fluid to the fluid conduit.

Various embodiments of a non-return valve comprise

a cylindrical valve seat insert that defines a fluid passageway and a valve seat terminating the fluid passageway, the valve seat insert defining an anchor recess;

a valve closure that includes
a valve flap having an external profile that corresponds with that of the insert;
a flexible hinge that is arranged on the valve flap; and
an anchor that is arranged on the flexible hinge so that the flexible hinge interconnects the anchor and the valve flap, the anchor and the anchor recess being dimensioned so that the anchor can be positioned in the anchor recess and retained in the anchor recess against movement in a direction of fluid flow; wherein

the anchor recess is positioned so that when the insert is secured within a conduit, an internal surface of the conduit partially closes the recess to define a chamber or volume in which the anchor is located and so that the valve flap can pivot between an open condition in which the external surfaces of the insert and the valve flap are located in a common cylindrical area and a closed condition in which the valve flap bears against the valve seat.

The recess and the anchor may be dimensioned so that the anchor is a loose fit in the chamber to allow a degree of movement of the valve flap other than pivotal movement between the open and closed conditions to allow the valve flap to settle in the closed condition.

The anchor and the recess may be generally T-shaped, with a leg of the anchor being connected to the flexible hinge.

### BRIEF DESCRIPTION OF THE DRAWINGS

FIG. 1 shows a cutaway three-dimensional view of an embodiment of a non-return valve.

FIG. 2 shows another cutaway three-dimensional view of the non-return valve of FIG. 1.

FIG. 3 shows a schematic side-sectioned view of the non-return valve of FIG. 1.

FIG. 4 shows detail A in FIG. 3.

FIG. 5 shows a schematic sectioned plan view of the non-return valve of FIG. 1.

FIG. 6 shows detail B in FIG. 5.

FIG. 7 shows a side view of the non-return valve of FIG. 1.

FIG. 8 shows internal detail of the region C in FIG. 7.

FIG. 9 shows internal detail of the region D in FIG. 7.

FIG. 10 shows a plan view of the non-return valve of FIG. 1.

FIG. 11 shows internal detail of the region E in FIG. 10.

FIG. 12 shows a schematic side-sectioned view of the non-return valve of FIG. 1 with a valve closure in an open condition.

FIG. 13 shows detail F in FIG. 12.

FIG. 14 shows detail Gin FIG. 12.

FIG. 15 shows a plan view of the non-return valve of FIG. 12.

FIG. 16 shows an internal plan view of the non-return valve of FIG. 1.

FIG. 17 shows a side view with hidden detail of the non-return valve of FIG. 1.

FIG. 18 shows a plan view with hidden detail of the non-return valve of FIG. 1.

FIG. 19 shows an internal plan view of the non-return valve of FIG. 1 in an open condition.

FIG. 20 shows a schematic side-sectioned view of an embodiment of a non-return valve.

FIG. 21 shows a cutaway three-dimensional view of the non-return valve of FIG. 20.

FIG. 22 shows another cutaway three-dimensional view of the non-return valve of FIG. 20.

FIG. 23 shows a side sectioned view of an embodiment of a non-return valve.

FIG. 24 shows detail H of FIG. 23.

FIG. 25 shows a cutaway three-dimensional view of the non-return valve of FIG. 23.

FIG. 26 shows another cutaway three-dimensional view of the non-return valve of FIG. 23.

FIG. 27 shows an internal plan view of the non-return valve of FIG. 23.

FIG. 28 shows detail I of FIG. 27.

FIG. 29 shows a side view of an embodiment of a non-return valve in an open condition.

FIG. 30 shows a three-dimensional view of the non-return valve of FIG. 23 in the open condition.

FIG. 31 shows a three-dimensional view of the non-return valve of FIG. 23 in the closed condition.

FIG. 32 shows a side view of the non-return valve of FIG. 29 in a closed condition.

FIG. 33 shows a plan view of the non-return valve of FIG. 29 in a closed condition.

FIG. 34 shows a three-dimensional sketch of an embodiment of a non-return valve indicating different forms of material.

FIG. 35 shows a plan sectioned view of an embodiment of a non-return valve.

FIG. 36 shows an internal view of an embodiment of a non-return valve.

FIG. 37 shows a schematic side view of a first step in the mounting of an embodiment of a non-return valve in a conduit.

FIG. 38 shows a schematic side view of a second step in the mounting of an embodiment of a non-return valve in a conduit.

FIG. 39 shows a schematic side view of a third step in the mounting of an embodiment of a non-return valve in a conduit.

FIG. 40 shows a schematic internal side view of the non-return valve of FIG. 39 with a valve flap in an open condition.

FIG. 41 shows a schematic internal side view of the non-return valve of FIG. 39 with the valve flap in a partially open condition.

FIG. 42 shows a schematic internal side view of the non-return valve of FIG. 39 with the valve flap in a closed condition.

FIG. 43 shows a three-dimensional view of a reinforcing structure for the valve flap of an embodiment of a non-return valve.

FIG. 44 shows a schematic side view of the reinforcing structure of FIG. 43 in position.

FIG. 45 shows a three-dimensional view of an embodiment of a non-return valve in a closed condition.

FIG. 46 shows a three-dimensional view of an embodiment of a valve flap for a non-return valve, partially delaminated to illustrate the structure of the valve flap.

FIG. 47 shows a detailed plan view of part of the valve flap of FIG. 46.

FIG. 48 shows a partly cutaway view of the non-return valve of FIG. 45 mounted in a conduit.

FIG. 49 shows a three-dimensional view of another embodiment of a valve flap for a non-return valve.

FIG. 50 shows another three-dimensional view of the valve flap of FIG. 49.

FIG. 51 shows a three-dimensional view of a latch for connecting the valve flap of FIG. 49 to a valve insert.

FIG. 52 shows a three-dimensional view of an embodiment of a valve insert for a non-return valve.

FIG. 53 shows an embodiment of a non-return valve.

FIG. 54 illustrates a size difference between various embodiments of a non-return valve and a conventional foot valve.

FIG. 55 further illustrates the size difference between various embodiments of a non-return valve and a conventional foot valve.

FIG. 56 further illustrates the size difference between various embodiments of a non-return valve and a conventional foot valve.

FIG. 57 shows a duckbill valve of the prior art.

### DETAILED DESCRIPTION

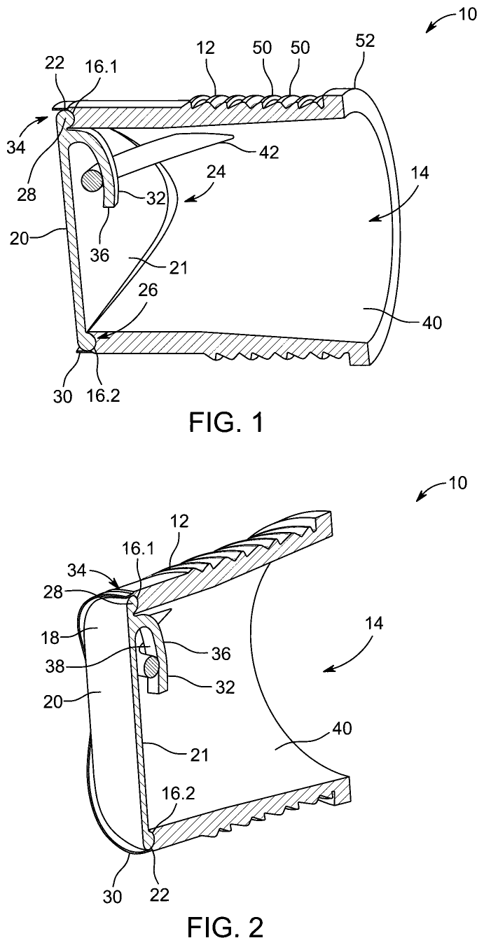

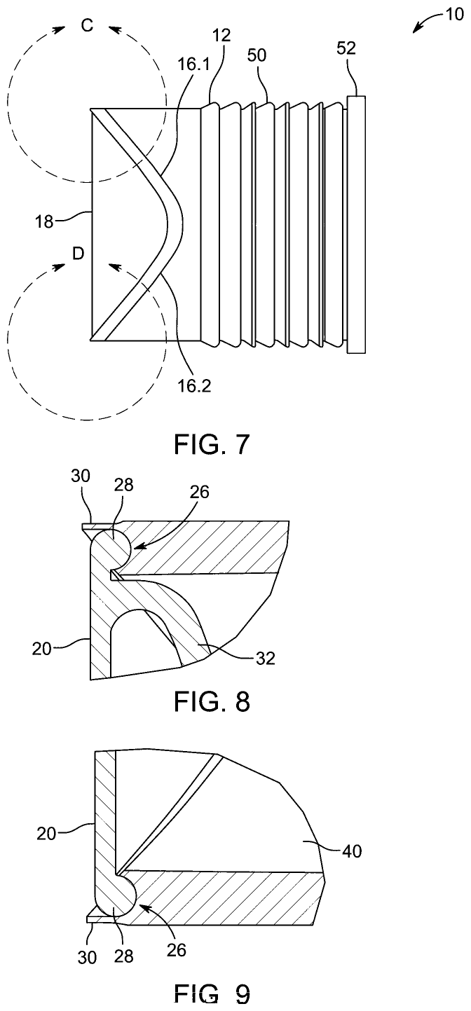

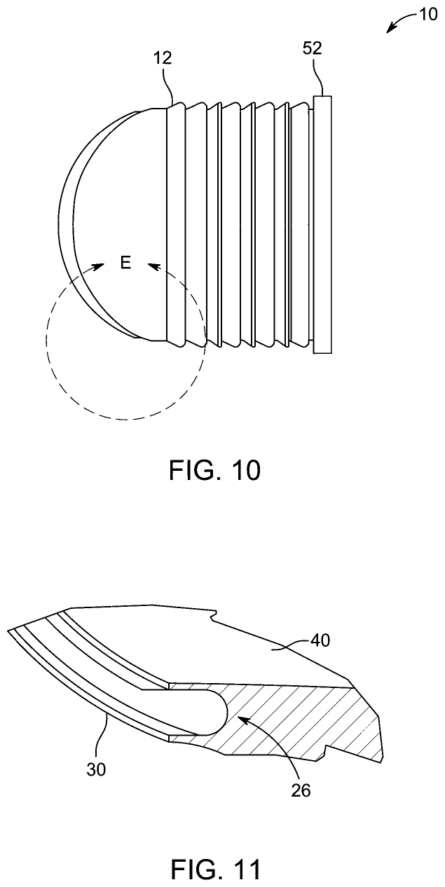

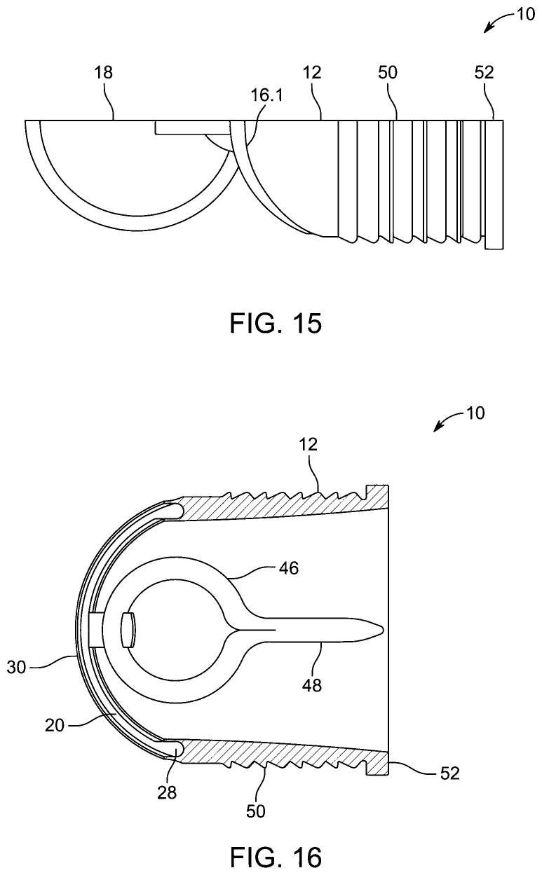

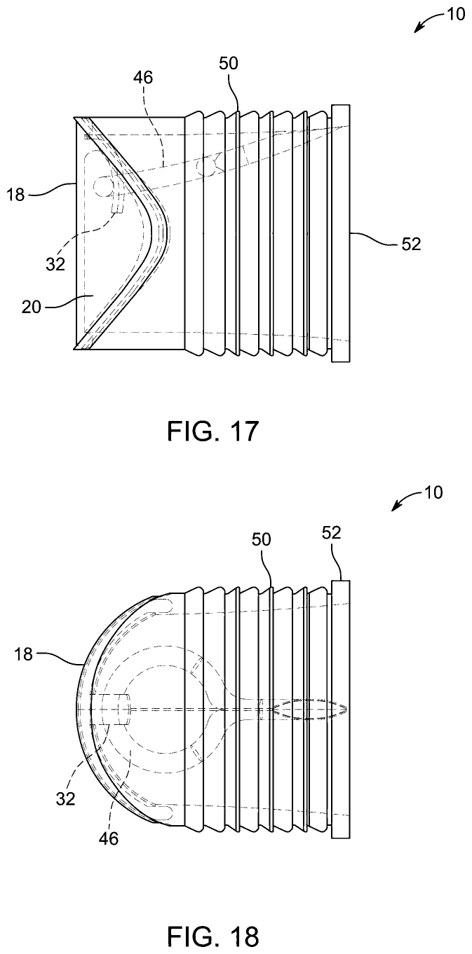

In FIGS. 1 to 19, reference numeral 10 generally indicates an embodiment of a non-return valve.

The non-return valve 10 includes a cylindrical valve seat insert 12. The valve seat insert 12 defines a fluid passageway 14. A valve seat 16 terminates the passageway 14. The valve insert 12 can be of an elastomeric material, such as natural or synthetic rubber. The valve seat 16 can be of a similar material and can be integral to the insert 12 or may be defined by an over-moulded portion.

The valve 10 includes a valve closure 18. The valve closure 18 includes a valve flap 20. The valve flap 20 has a periphery 22 that is configured to bear against the valve seat 16 so that the fluid passageway 14 can be sealed.

The valve flap 20 can be of a harder material than the valve seat 16. For example, the valve flap 20 can be relatively rigid compared to the valve seat 16. In some embodiments, the valve periphery 22 of the valve flap 20 can define an edge that is capable of being embedded in the valve seat 16 to facilitate sealing between the valve seat 16 and the valve flap 20. In other embodiments, the valve seat 16 can define an edge that is capable of being embedded in the periphery 22. It will be understood that the selection of materials will determine which component defines the edge.

The valve seat 16 defines a proximal seat 16.1 and a distal seat 16.2. In this example, the word “proximal” is used to define an area or region that is closer to a hinge point of the valve closure 18 than an area or region that is described as “distal”.

The proximal seat 16.1 and the distal seat 16.2 lie in respective intersecting planes. The proximal seat 16.1 transitions to the distal seat 16.2 via a curved transition zone 24. The plane of the proximal seat 16.1 and the plane of the distal seat 16.2 are symmetrical about a plane of an axis that is parallel to, and/or co-directional with, a line representing a direction of fluid flow through the insert 12. It follows that, when closed, the valve flap 20 is oriented generally orthogonally with respect to a direction of fluid flow through the insert 12. Thus, when open, the valve flap 20 is oriented substantially axially in the flow direction and, when closed, is substantially perpendicular to the flow direction.

An included angle defined between the planes of the proximal and distal seats 16.1, 16.2 is between approximately 60° and 180°. However, it is to be appreciated that this included angle can vary depending on the application.

The valve seat 16 defines an annular recess 26 that opens in a direction of normal fluid flow through the insert 12 when the valve flap 20 is in an open condition. The annular recess 26 has an arcuate transverse profile.

The periphery 22 of the valve flap 20 is defined by a ridge 28 having an arcuate transverse profile that corresponds with that of the annular recess 26. The ridge 28 is capable of nesting in the recess 26. This facilitates sealing of the flap 20 to the valve seat 16. The dimensions of the ridge 28 and the recess 22 vary depending on a diameter of the insert 12. For example, for a 50 mm insert, the recess 22 and the ridge 28 may have a diameter of between about 2 mm and 5 mm. Smaller and larger inserts suitable for smaller and larger conduits require further proportionate dimensions.

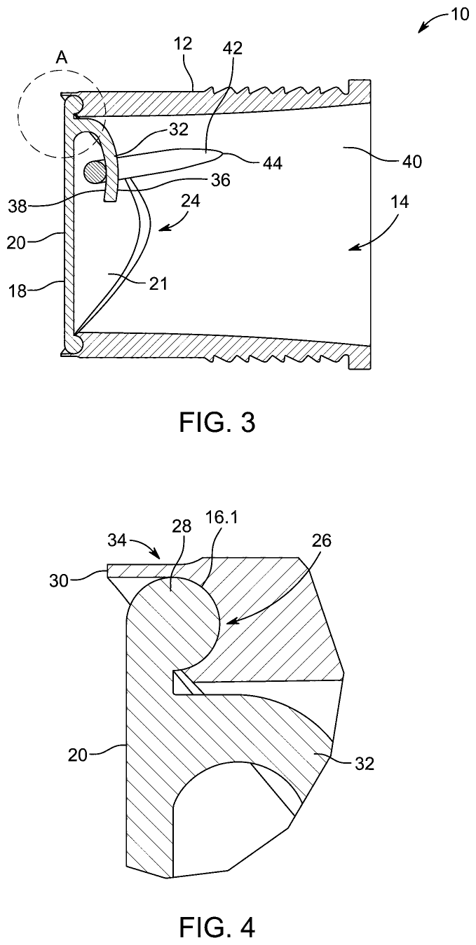

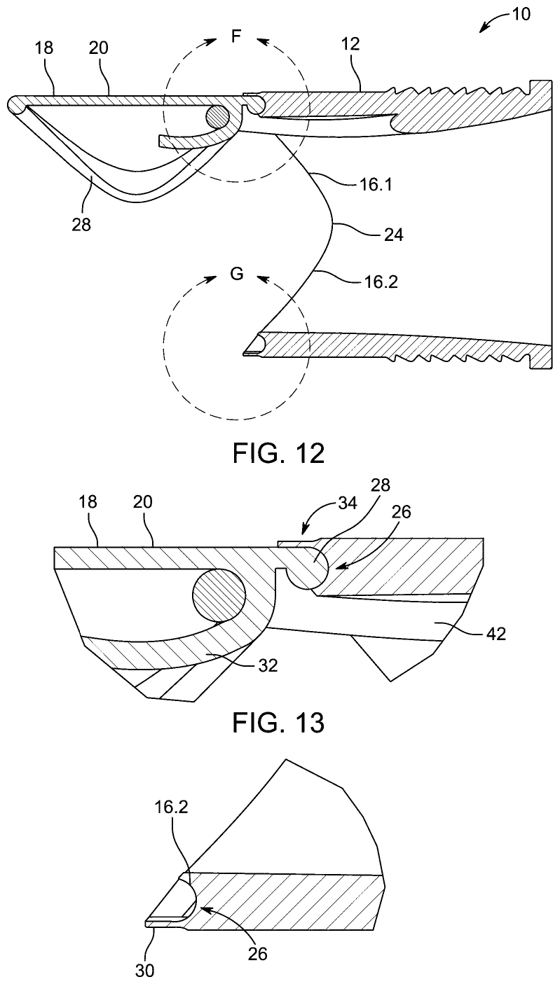

Furthermore, the corresponding profiles of the ridge 28 and the recess 26 allow the valve flap 20 to pivot between a closed position, for example shown in FIG. 3 and an open position, for example shown in FIG. 12, about a pivot region 34. It has been found that any interference that may result from the arcuate shape of the ridge 28 and the recess 20 is accommodated due to the fact that the environment is water-lubricated. Also, the region 34 is relatively small compared to the remaining parts of the ridge 28 and recess 20.

An outer lip 30 extends from an outer edge of the valve seat 16 in the general direction of normal fluid flow. The lip 30 is dimensioned to extend beyond or to overhang the outer surface of the valve flap 20. The lip 30 is of a suitable thickness so that it can deform and press against the outer surface of the valve flap 20 as a result of backpressure when the valve flap 20 is closed. This further facilitates sealing of the flap 20 to the valve seat 16. The lip 30 is dimensioned to extend from about 2 mm to any further practical distance generally orthogonally from a plane that bisects the ridge 28. The lip 30 can have a thickness greater than about 0.1 mm. An upper limit of the thickness can be determined by an ability to fabricate the lip 30 in a moulding process. It will be appreciated that the characteristics of the lip 30 will be selected depending upon the contemplated application of the non-return valve. Thus, the characteristics of the lip 30 will be selected so that, with a contemplated backpressure, the lip 30 can deform and bear against the valve flap 20 to enhance sealing of the valve flap 20 and the valve seat 16.

It is envisaged that the characteristics of the lip 30 can also be a function of a size of the non-return valve 10.

An inner lip 31 (FIG. 6) extends from an inner edge of the valve seat 16. The lip 31 also has a suitable thickness so that it can deform and press against an inner surface of the ridge 28. As a result, when the valve flap 20 is in the closed condition, the lips 30, 31 define a seal on both sides of the valve flap 20. As a result, the ridge 28 can be retained in the recess 26 as a result of a vacuum set up within the recess 26 or simply by the enhanced sealing achieved as a result of the configuration described above. This can serve to inhibit leakage of fluid when a backpressure is set up within the conduit. The inner lip 31 can have characteristics similar to that of the outer lip 30.

For example, in an application in which the fluid is liquid, such as water, it may be the case that a pressure drop occurs in the water upstream of the valve 10 such that water pressure upstream of the valve 10 is less than water pressure downstream of the valve 10. In this situation, the fact that air is inhibited from passing between the valve seat 16 and the valve flap 20 results in the water been maintained within the conduit, in contact with an inner side 21 of the valve flap 20. Thus, the breakdown or discontinuation of priming water in the system is obviated or avoided when the water level within the system returns to a normal position. It will be appreciated that, in the event of leakage, subsequent priming of a pump, upstream of the non-return valve 10 could be problematic. The fact that the priming water is retained in an operative condition or position, results in start-up optimisation of the pump. This can result in significant energy savings than would be the case if the pump required priming.

The lips 30, 31 are of an elastomeric material, such as natural or synthetic rubber. In this example, the lips 30, 31 form an integral part of the insert 12.

In other embodiments, the insert 12 can be in two parts, with one part of a relatively rigid material and another part of a resiliently flexible material and defining the valve seat 16 and the lips 30, 31.

A biasing mechanism is interposed between the flap 20 and an internal surface 40 of the insert 12. The biasing mechanism is configured and arranged with respect to the valve flap 20 such that a level of bias is adjusted to facilitate movement of the valve flap 20 into the open condition. In particular, the biasing mechanism is configured and arranged with respect to the valve flap 20 such that the level of bias is reduced as the valve flap 20 moves towards its open condition. This is achieved by the biasing mechanism being displaced both pivotally and linearly with respect to the valve flap 20. The biasing mechanism is configured to bias the valve flap 20 into the closed condition. The biasing mechanism is further configured so that a bias is applied as the valve flap 20 moves from the closed condition. As the valve flap 20 opens beyond a predetermined extent, the bias is maintained but does not increase to an extent determined by the extent of movement of the flap 20. Thus, an initial predetermined pressure is required to open the valve flap 20 after which the valve flap 20 moves into the open condition against a bias that is such that the valve flap 20 can move fully into the open position. As soon as flow stops, the valve flap 20 experiences the bias from the biasing mechanism to initiate movement of the valve flap 20 towards the closed condition.

The biasing mechanism serves to pull the valve flap 20 into engagement with the valve seat 16. This can enhance sealing between the valve flap 20 in cases of low fluid pressure upstream of the non-return valve 10. This can also enhance sealing in cases of lack of manufacturing precision. This is particularly the case where the valve flap is of a harder material then the valve seat 16. For example, the biasing mechanism can serve to generate a relatively small compression of the valve seat 16 so that it can conform to the periphery of the valve flap 20.

The biasing mechanism includes a hook or catch 32 that is fixed to an inner side of the valve flap 20. The catch 32 includes a catch arm 36 that extends to a predetermined length from a proximal end secured or fixed to the valve flap 20 at or near the hinge mechanism 34 towards a diametrically opposite distal end and defines a catch surface 38 that is spaced from the inner side of the valve flap 20. In this example, the catch surface 38 curves outwardly from the hinge mechanism 34, and then inwardly towards the valve flap 20.

A resilient elongate extendable member is fixed, at one end, to the internal surface 40 of the insert 12 at a position that is proximal with respect to the distal end of the catch surface 38. An opposite end of the resilient elongate extendable member engages the catch surface 38 and is capable of sliding with respect to the catch surface 38. Thus, as the valve flap 20 opens, the catch 32 acts initially directly against the resilient member. As a result, the opposite end of the resilient member slides along the catch surface 38 to accommodate the movement of the valve flap 20. Thus, instead of the elongate member stretching or extending further and further as the valve flap 20 opens, so increasing the bias, the opposite end slides towards the hinge mechanism. This amplifies a lever effect of the catch arm 36 as it pivots about the ridge 28. As result, movement of the flap 20 into the open condition is facilitated.

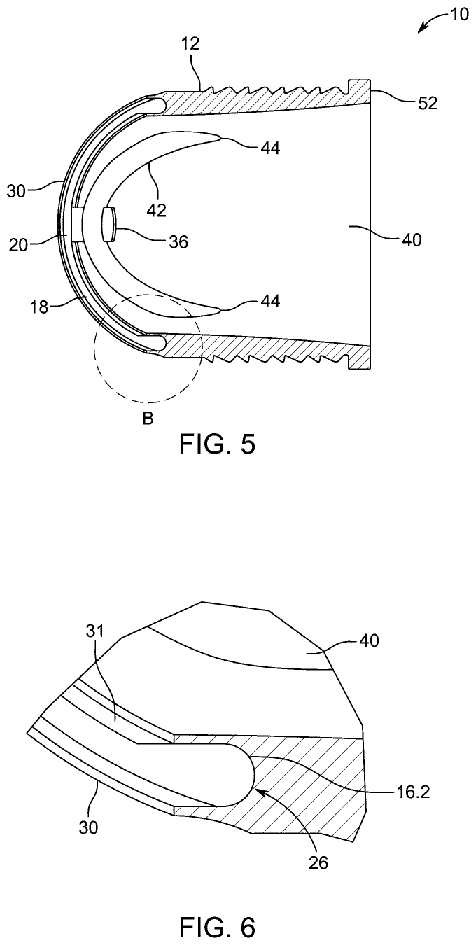

The resilient elongate member can be in the form of a length 42 of elastomeric material such as natural or synthetic rubber. As can be seen in FIG. 5, opposite ends 44 of the length 42 are fixed to the internal surface 40. Alternatively, as can be seen in FIG. 16, the resilient elongate member can be in the form of an eye or loop 46 of the elastomeric material that is hooked over the catch arm 36. A shank 48 of the loop 46 is fixed to the internal surface 40.

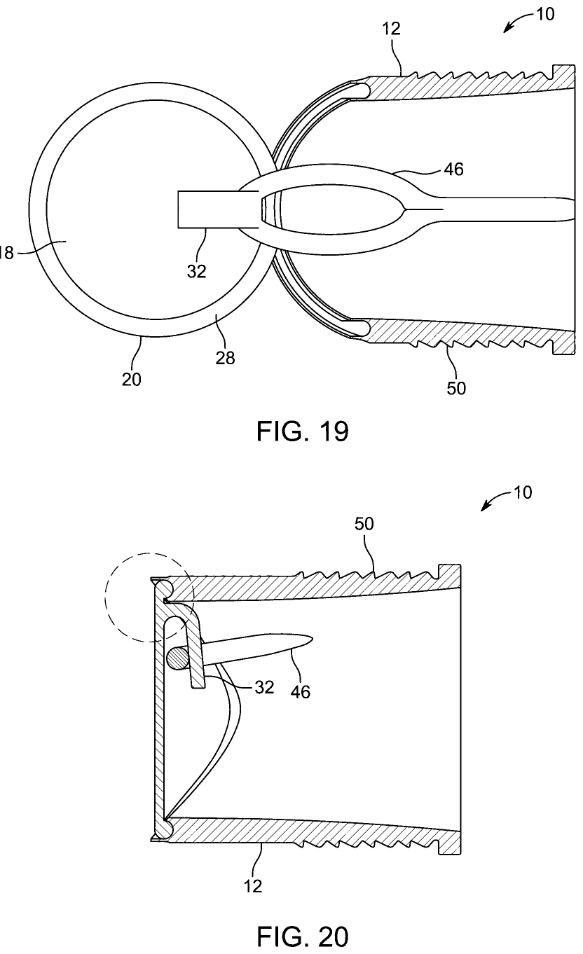

In FIG. 16, the loop is in an initial generally circular state in which the valve closure 18 is in the closed condition. In the open condition shown in FIG. 19, the loop 46 is shown stretched such that it becomes elliptical as it accommodates pivotal movement of the valve closure 18 into the open condition.

Various other forms of resiliently extendable members can be used to achieve similar results as those achieved with the length 42 or loop 46.

The insert 12 can be mounted in a conduit in a number of different ways, some of which will be described in further detail below.

In one embodiment, the insert 10 defines a series of annular serrations 50 or ridges that are oriented so that the insert 12 can be pushed into the conduit but inhibited from being withdrawn from the conduit. Thus, the material of the insert 12 can be selected so that the serrations 50 can dig into the conduit when an ejection pressure is exerted on the valve closure 18 while it is in the closed condition. The serrations 50 can be discreet or can be arranged helically so that the insert can be screwed into the conduit.

The insert 12 includes a flange 52 at a delivery end of the insert 12. Thus, in use, the insert 12 can be pushed into the conduit such that the flange 52 abuts an end of the conduit.

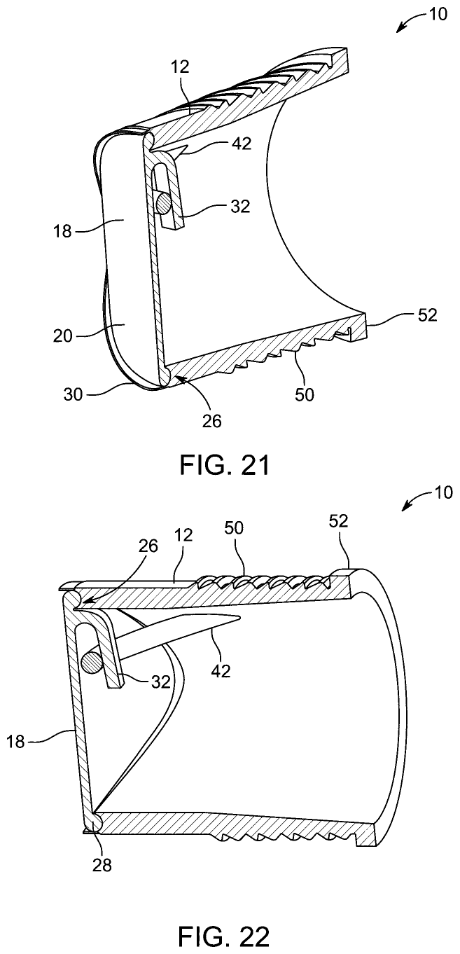

In FIGS. 20 to 22, reference numeral 60 generally indicates a further embodiment of a non-return valve. In this embodiment, the catch arm 36 is generally straight as opposed to being curved as in the above embodiment. Here, the catch arm 36 is of a suitable length such that the resilient member does not drop off or slide off the arm 36. Also, in this embodiment, the length of elastomeric material 42 can serve to generate right to left and vice versa forces with respect to a direction of normal fluid flow to provide a level of settling of the valve flap 20 on the valve seat 16. Such settling can enhance a seal between the valve flap 20 and the valve seat 16.

The settling is further enhanced by the fact that the portion of the ridge 28 that pivots relative to an associated portion of the recess 26 is not fixed to the insert 12 by means of a physical hinge or other form of pivot mechanism. This allows a certain amount of non-pivotal movement or linear movement of the valve flap 20 relative to the valve seat 16 to allow the settling. Such settling can be effective in accommodating various inconsistencies in the valve flap 20 and valve seat 16 as a result of manufacturing faults or lack of precision and even as a result of detritus and other particles being jammed between the valve flap 20 and the valve seat 16. For example, the flap 20 can rotate to a certain degree about its own axis that is co-linear with, or parallel to, a direction of fluid flow. Also, the flap 20 can shift to a certain degree in a plane that is orthogonal to, or angled with respect to, the direction of fluid flow. The fact that the elastomeric member 42 is not fastened to the catch 32 and is capable of some movement relative to the catch 32 also facilitates the settling of the valve flap 20 on the valve seat 16.

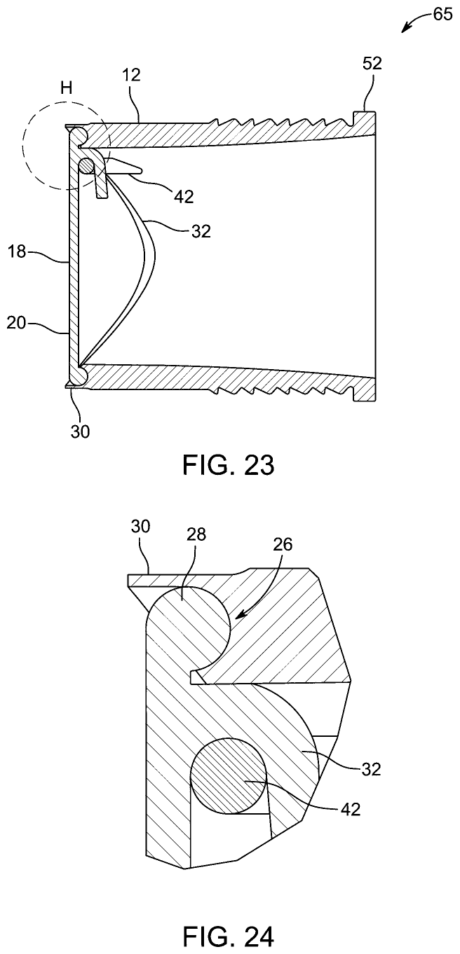

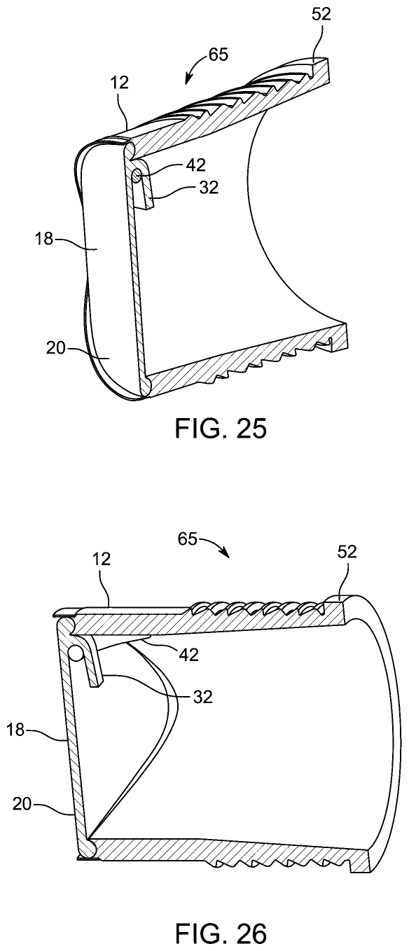

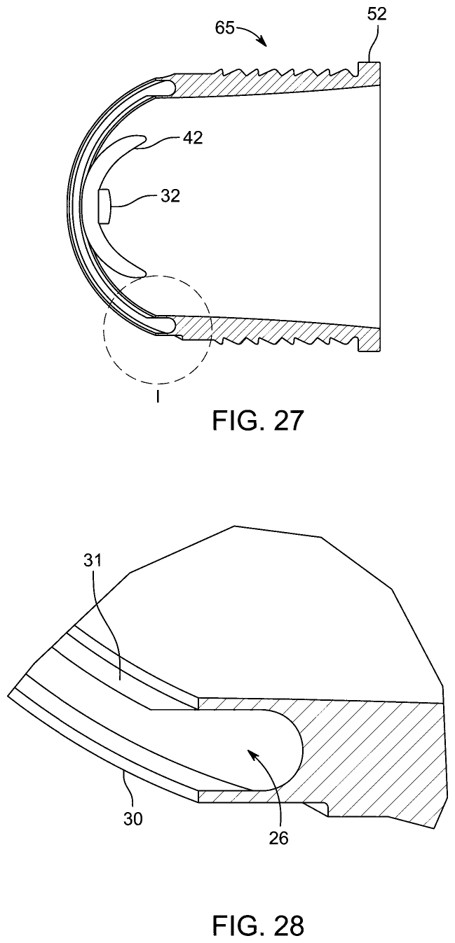

In FIGS. 23 to 28, reference numeral 65 generally indicates a further embodiment of a non-return valve. In this embodiment, the elastomeric member 42 is shorter than in the previous embodiments. As a result, the catch arm 36 can also be shorter. In this embodiment, the catch arm 36 is generally straight.

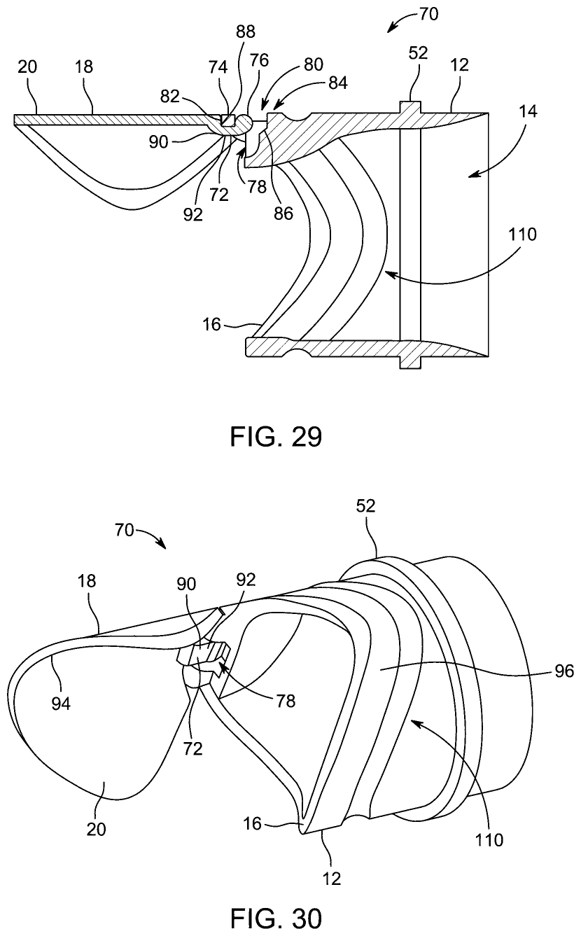

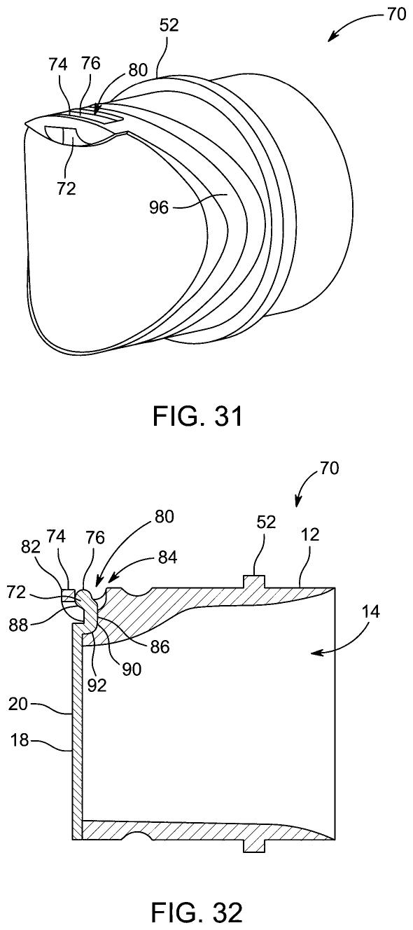

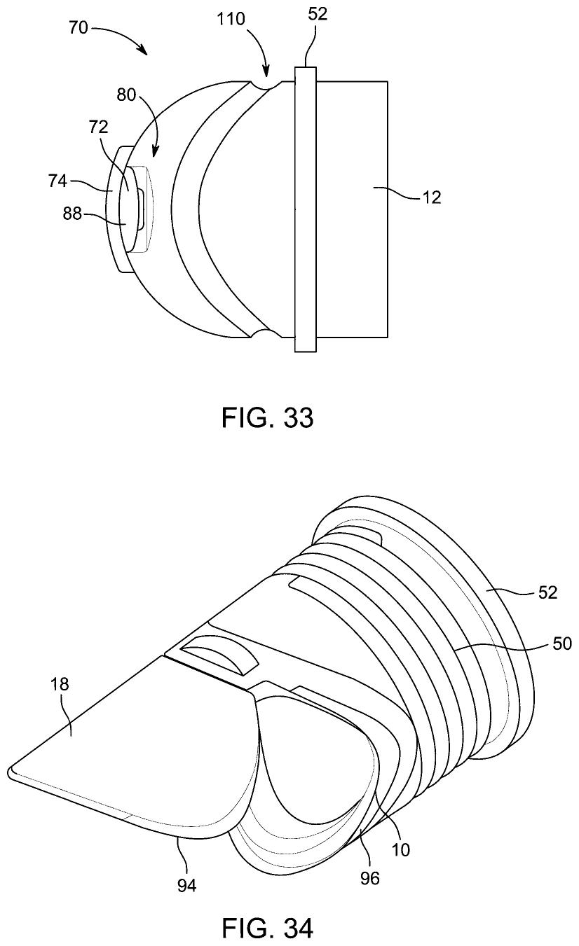

In FIGS. 29 to 33, reference numeral 70 generally indicates an embodiment of a non-return valve.

The insert 12 includes a valve closure retainer 74. The non-return valve 70 includes an anchor 72 that is arranged on the valve flap 20 and is anchored to the retainer 74 so that the anchor 72 can pivot with respect to the insert 12 between the open condition in which external surfaces of the insert 12 and the valve flap 20 are located in a common cylindrical area and a closed condition in which the valve flap 20 bears against the valve seat 16. The anchor 72 and the retainer 74 are configured so that the anchor 72 is constrained to a limited amount of linear movement relative to the retainer 74 during pivotal movement between the open and closed conditions to facilitate sealing of the valve flap 20 and the valve seat 16 as result of settling.

The anchor 72 defines a pivot formation 76. The retainer 74 defines an aperture 78. The anchor 72 is dimensioned to extend through the aperture 78 with the pivot formation 76 located and retained partially externally of the valve seat 16.

The aperture 78 opens externally into a recess 80 defined by the retainer 74 so that the pivot formation 76 can pivot within the recess 80.

The retainer 74 includes a pivot member 82 at a front of the recess 80. The pivot formation 76 is shaped so that it can hook onto and pivot about the pivot member 82. The recess 80 and the pivot formation 76 are dimensioned so that, when the valve flap 20 is in the open condition, a gap 84 is defined between the pivot formation 76 and rear surfaces 86 of the recess 80 and the aperture 78 to provide an extent of play of the valve closure 18 with respect to the insert 12 when the valve flap 20 moves into the closed condition.

The pivot formation 76 includes a cross bar 88 that can be retained in the recess 80 and inhibited from being drawn through the aperture 78. The pivot formation 76 includes a neck 90 that interconnects the valve flap 20 and the cross bar 88. The anchor 72 defines a transverse profile that corresponds with that of the pivot member 82 so that, when the valve flap 20 is in the open condition (FIGS. 29 and 30), the pivot member 82 and the anchor 72 nest so that the valve flap 20 is retained in the open condition.

In use, the insert 12 is positioned in a conduit, as will be described in further detail below. The recess 80 is located so that an internal surface of the fluid conduit serves to close the recess 80. The extent of play is such that, when the valve closure 18 fits into the closed condition, the valve closure 18 is constrained to move linearly by the internal surface of the fluid conduit such that the pivot formation 76 moves into a position in which the crossbar 88 is retained in the recess 80 (FIG. 26). During such linear movement, the valve flap 20 is permitted to settle on the valve seat 16.

As can be seen in FIG. 32, an internal surface 92 of the anchor 72 and the valve flap 20 and a proximal portion 94 of the valve seat 16 are complementary so that the surface 92 and the portion 94 can nest to facilitate sealing.

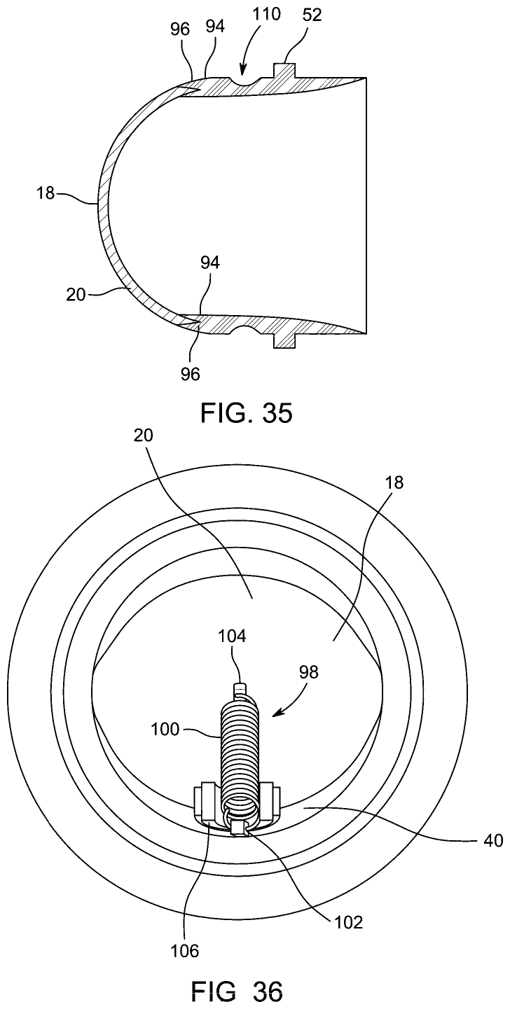

A periphery of the valve flap 20 is chamfered or tapered to define an edge 94. The valve seat 16 is defined by a seat member 96 that is of a softer material than the valve flap 20. Thus, when the valve flap 20 is in the closed condition, the edge 94 can embed itself into the valve seat 16 to enhance sealing. This is illustrated in FIGS. 34 and 35.

In FIG. 36 there is shown an option in which a biasing mechanism 98 is interposed between the internal surface 40 of the insert 12 and the flap 20. The biasing mechanism 98 is configured so that the flap 20 can open against a bias of the mechanism 98. Thus, movement of the flap 20 into the closed condition can be assisted by the biasing mechanism 98. The biasing mechanism 98 includes a coil spring 100. One end of the coil spring is connected to the internal surface 40 via a hook or other mounting formation 102. An opposite end of the coil spring 100 is connected to a further hook or mounting formation 104 arranged on the flap 20. A shield or protective collar 106 is mounted on the internal surface 40 to shield the internal surface 40 from the spring 100.

The mounting formation 104 can be configured to define a sliding surface, similar to the catch surface 38 of the non-return valve 10 so that the non-return valve of FIG. 36 can operate in a similar fashion to that of the non-return valve 10.

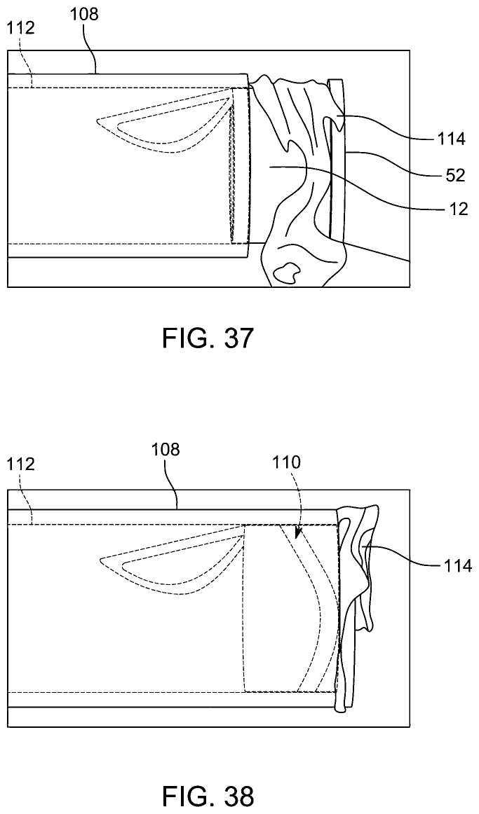

The insert 12 can be mounted in a conduit 108 as shown in FIGS. 37 to 39. The insert 12 defines a circumferentially extending recess or channel 110. The channel 110 is filled with a composition or compound 114 that is configured to adhere to an internal surface 112 of the conduit 108 and not to the material of the insert 12. For example, the insert 12 can be of synthetic or artificial rubber and the conduit can be of a plastics material. In that case, the composition or compound can be of a selected adhesive or an automotive body filler. It will be appreciated that the composition or compound can thus serve as an internal flange, once hardened, to retain the insert 12 in the conduit 108 without the need for making modifications to the conduit 108.

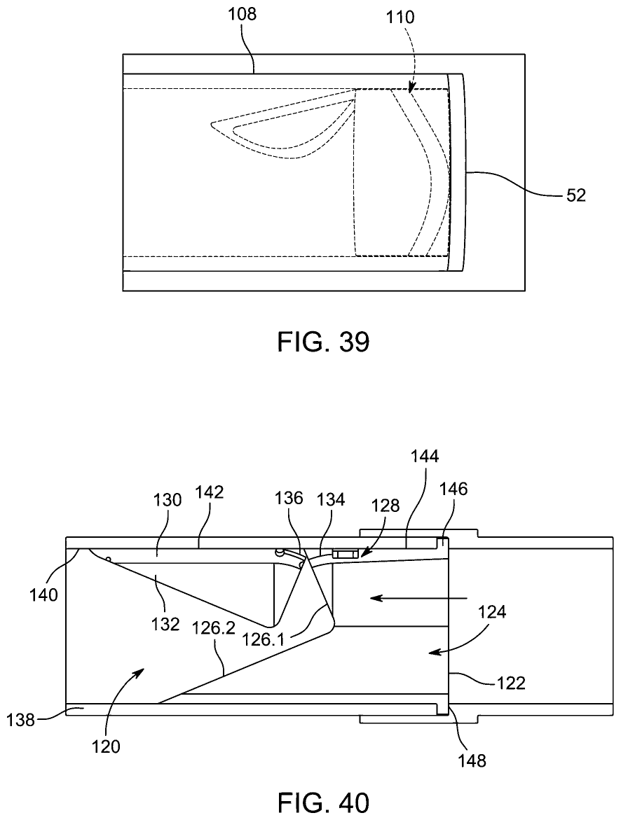

In FIG. 37, the composition or compound is positioned in the channel 110 for example by squirting. The insert 12 is then pushed into the conduit 108 until the flange 52 bears against an inlet of the conduit 108 (FIG. 38). During this step, the inlet 108 serves to swipe or cut excess composition or compound off the conduit 108. The excess composition or compound can be removed to clean up the conduit 108 (FIG. 39).

In FIGS. 40 to 42, reference numeral 120 generally indicates an embodiment of a non-return valve.

The non-return valve 120 has a cylindrical valve seat insert 122 that defines a fluid passageway 124 and a valve seat 126 that terminates the fluid passageway 124. The insert 122 defines an anchor recess 128.

The non-return valve 120 includes a valve closure 130. The valve closure 130 has a valve flap 132. The valve flap 132 has an external profile that corresponds with that of the insert 122. An anchor 136 is arranged on the valve flap 132 and incorporates a flexible hinge 134.

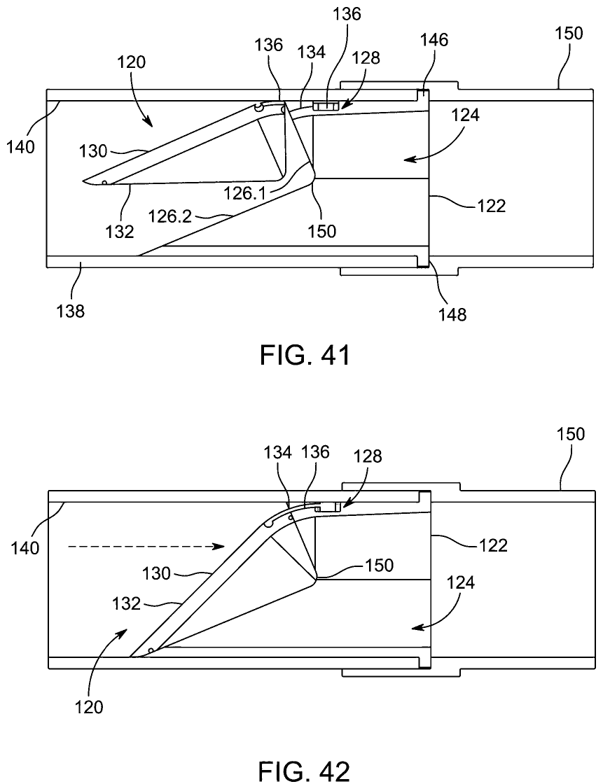

The anchor 136 and the anchor recess 128 are dimensioned so that the anchor 136 can be positioned in the anchor recess 128 and retained in the anchor recess 128 against movement in a direction of fluid flow. The anchor recess 128 is positioned so that, when the insert 122 is secured within a conduit 138, an internal surface 140 of the conduit 138 partially closes the recess 128 to define a chamber or volume in which the anchor 136 is located and so that the valve flap 132 can pivot between an open condition in which external surfaces 142, 144 of the valve flap 132 and the insert 122, respectively, are located in a common cylindrical area, for example, as shown in FIG. 40, and a closed condition in which the valve flap 132 is in a closed condition in which the valve flap 132 bears against the valve seat 126, for example, as shown in FIG. 42. FIG. 41 shows an intermediate position of the valve flap 132.

The recess 128 and the anchor 136 are dimensioned so that the anchor 136 is a loose fit in the chamber formed when the recess 128 is partially closed by the internal surface 140 of the conduit 138.

The anchor 136 and the recess 128 can be in the form of various shapes to ensure that the anchor 136 is retained in the recess 128. Examples of these are described in further detail below.

As can be seen in FIGS. 40 to 42, the insert 122 includes a flange 146 at a fluid delivery end of the insert 122. When installed, the flange 146 can be brought into abutment with an inlet of the conduit 138. The flange 146 can be sandwiched between the inlet of the conduit 138 and a shoulder 148 of a connecting pipe 150. When the pipe 150 is secured to the conduit 138, in an overlapping manner, the flange 146 is secured in position thereby inhibiting axial displacement of the insert 122.

The valve seat 126 defines a proximal seat 126.1 and a distal seat 126.2. The words “proximal” and “distal” have the same meaning as above with reference to the anchor recess 128.

The proximal seat 126.1 and the distal seat 126.2 lie in respective intersecting planes. The proximal seat 126.1 transitions to the distal seat 126.2 via a curved transition zone 150.

The plane of the proximal seat 126.1 can be oriented at an angle of between about 90° and 135° relative to an x-axis that is parallel to, and codirectional with, a line representing a direction of fluid backflow. For example, the angle can be between about 100° and 120° relative to the x-axis. The plane of the distal seat 126.2 can be oriented at an angle of between about 210° and 225° relative to the x-axis. For example, the distal seat 126.2 can extend in the direction of fluid flow to a greater extent than the proximal seat 126.2. Thus, the valve flap 132 is angled from the anchor 136 in a fluid flow direction. It is to be appreciated that these angles can vary depending on a contemplated application of the valve 120.

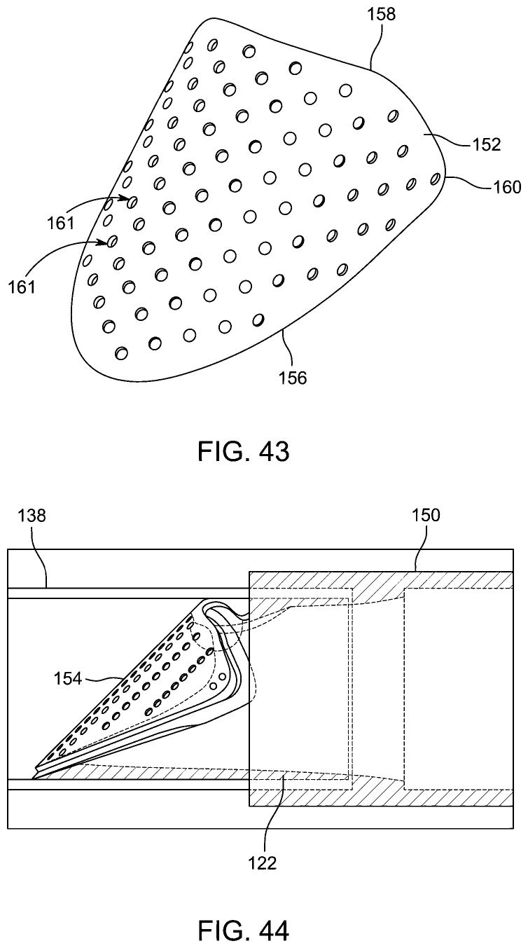

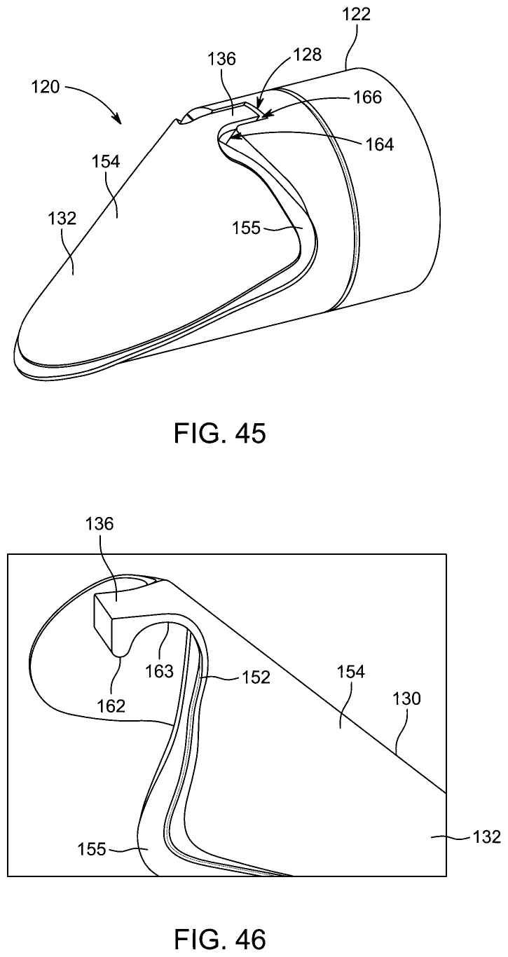

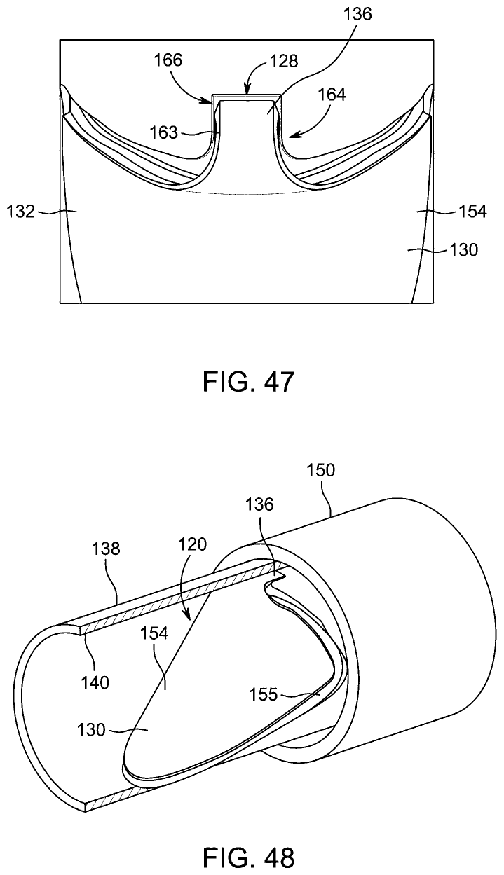

FIGS. 43 and 44 illustrate a structure of the valve flap 132. The valve flap 132 includes a support structure 152 that is positioned on, or embedded in, a flexible or elastomeric body 154 to provide structural integrity to the flexible body. The support structure 152 is in the form of a relatively stiff material, compared to the material of the body 154. For example, the support structure 152 is in the form of a relatively rigid plastics material. The support structure 152 imparts shape to the valve flap 132. Thus, the support structure 152 is in the form of a sheet of the suitable material that is bounded by a distal edge 156, a proximal edge 158 and curved transitional edges 160 that interconnect the distal and proximal edges 156, 158. The distal edge 156 transcribes a semi-elliptical path as does the proximal edge 158. A focal length of the distal edge 156 is greater than a focal length of the proximal edge 158. Thus, a transverse profile of the support structure 152 is arcuate or curved in a plane at right angles to a centreline of the insert 122

In this embodiment, the support structure 152 is embedded in the body 154. Furthermore, the support structure 152 defines openings 161 to inhibit the delamination or separation of the body 154 and the support structure 152. The openings 161 can also serve to minimise a weight of the valve flap 132.

Further, in this embodiment, the valve seat 126 can be of a harder material than the body 154. Thus, the valve seat 126 can seal against the body 154. In one example, the valve seat 126 can define a chamfered or tapered edge that is capable of embedding itself into the body 154 when the valve flap 132 is in the closed condition. This facilitates sealing.

Furthermore, the body 154 can define a peripheral sealing lip or skirt 155 that is configured to bear against the valve seat 126 when the valve flap 132 is in the closed condition. The skirt 155 is thus of a rubber-like or elastomeric material. The valve seat 126 can be finished so that the skirt 155 can engage the seat 126 such that a suction could be generated between the skirt 155 and the seat 126 if the passageway 124 was closed. For example, the valve seat 126 can be finished to be substantially glass-like for smoothness and regularity. Furthermore, back pressure in the conduit 138 can serve to urge the skirt 155 against the valve seat 126 further to enhance sealing of the valve seat 126 and the valve flap 132.

In an application in which the fluid is liquid, such as water, it may be the case that a water level downstream of the non-return valve 120 drops, as described with reference to the non-return valve 10. The above configuration can thus achieve a similar outcome to that described with reference to the non-return valve 10.

The anchor 136 can be integral with the body 154 (FIG. 46). The anchor 136 can include a thickened portion or lug 162. A connector 163 is interposed between the lug 162 and the flap 132. The connector 163 provides the flexible hinge 134 as result of the flexibility of the material of the body 154.

The anchor recess 128 is shaped to accommodate the connector 164 and the lug 162. Thus, the recess 128 includes a shallow portion 164 to accommodate the connector 164 and a deeper portion 166 to accommodate the lug 162.

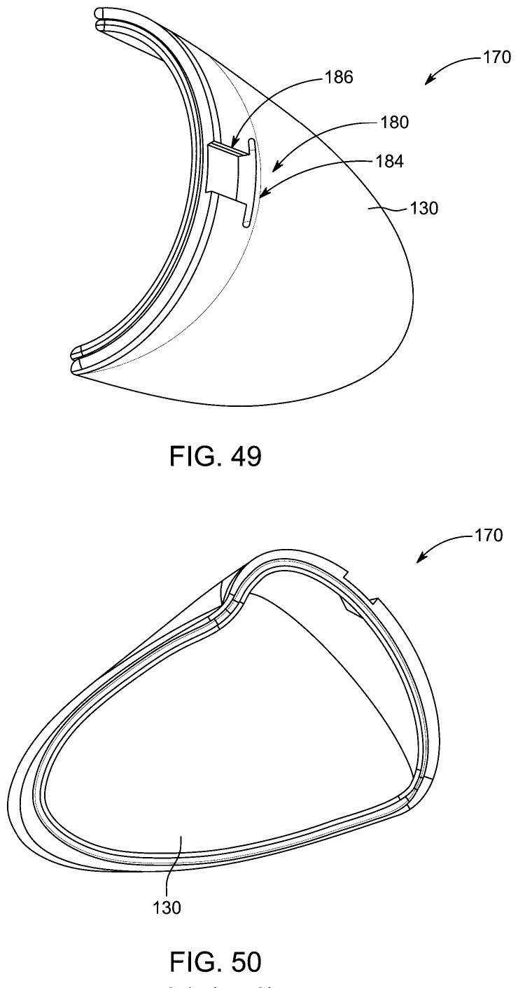

In FIGS. 49 and 50 there is shown an alternative valve closure 170 suitable for use with the non-return valve 120.

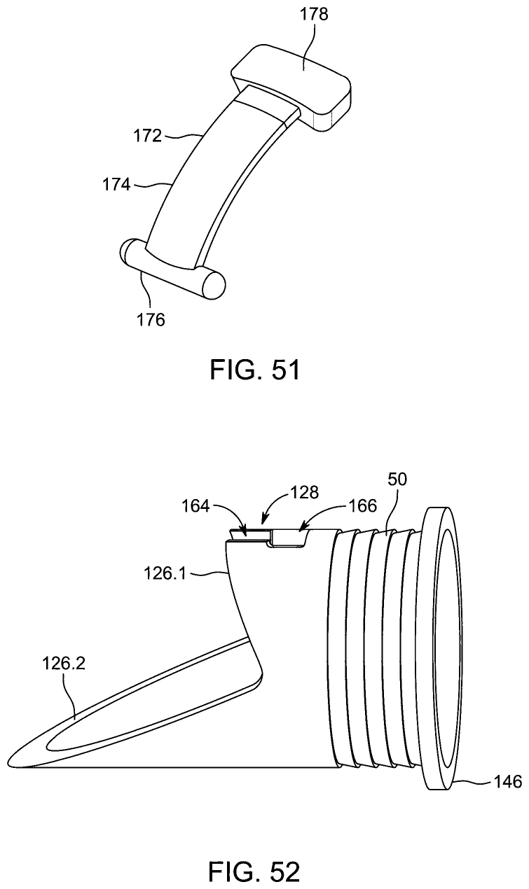

The valve closure 170 is connected to the insert 122 with a latch 172 (FIG. 51). The latch 172 includes a flexible hinge 174 that interconnects a flap anchor 176 and an insert anchor 178.

The valve flap 170 defines an anchor recess 180 that is shaped to accommodate the flap anchor 176 and a portion of the flexible hinge 174 so that the valve flap 170 is secured to the flexible hinge 174 when the valve flap 170 is in the open condition. Likewise, the anchor recess 128 is shaped to accommodate the insert anchor 178 and a portion of the flexible hinge 174 to secure the flexible hinge 174 to the insert 122. In particular, the insert anchor 178 is dimensioned to fit in the deeper portion 166 so that it can slide or move to and fro within the deeper portion 166 to a limited extent. The portion of the flexible hinge 174 is dimensioned to fit in the shallower portion 164.

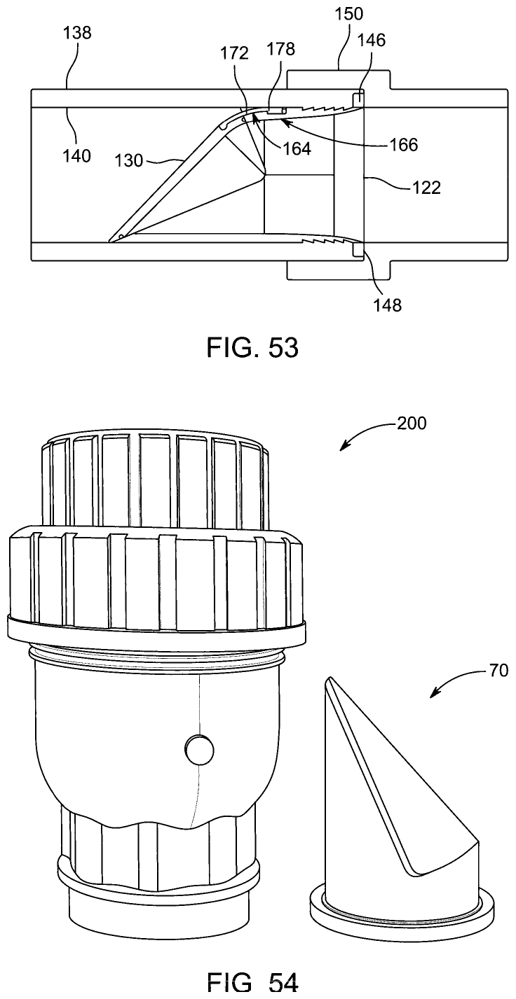

As can be seen in FIG. 53, for example, the conduit 138 serves to retain the insert anchor 178 in the anchor recess 128.

As can be seen in FIG. 51, the flexible hinge 174 is in the form of a strip of material. That material can be flexible and, for example, elastomeric.

The flap anchor 176 is in the form of a generally cylindrical cross bar on one end of the hinge 174. Thus, the anchor recess 180 includes a slotted portion 184 to receive and to retain the flap anchor 176 and a narrower, shallower portion 186 to receive the flexible hinge 174.

The insert anchor 178 is in the form of a block on an opposite end of the hinge 174.

It will thus be appreciated that, as the flap 170 pivots into the closed condition, the limited extent of movement of the block 188 can result in the valve flap 170 settling on the valve seat 126.

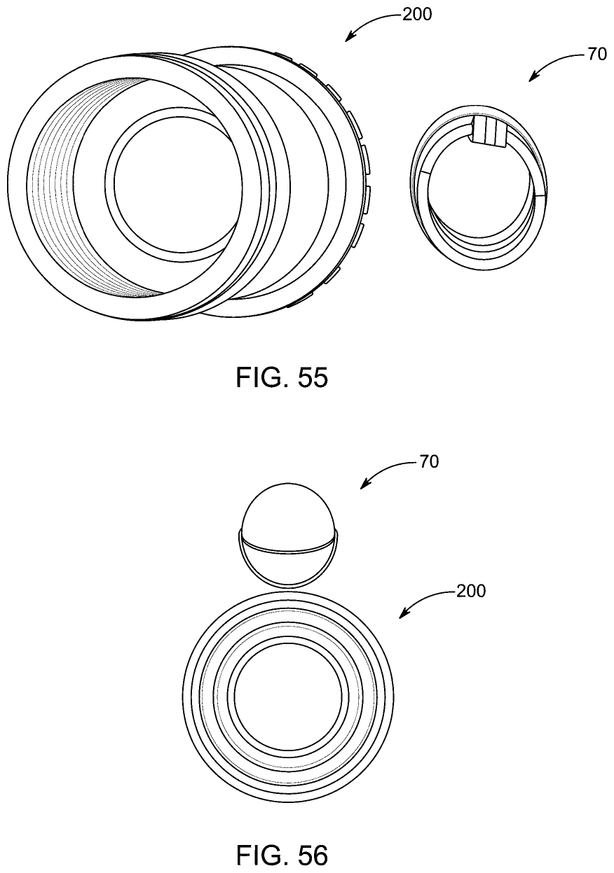

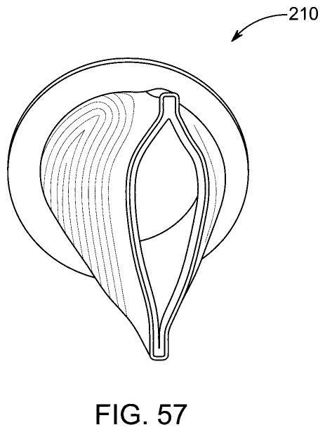

In FIGS. 54 to 56, reference numeral 200 generally indicates various views of a prior art foot valve. This is a 2 inch foot valve. The non-return valve 70 is shown next to the foot valve 200 to indicate the size difference with the improved functionality of the non-return valve 70. It will readily be appreciated that this size difference is applicable to all the embodiments of the non-return valve described above.

As is clear from the embodiments described above, the valve insert can fit entirely within a fluid delivery pipe. Furthermore, when the valve flap is open, a cross-sectional area of the fluid delivery pipe is maximised. This is facilitated, for example, by the fact that the valve flap has an external profile that corresponds with that of the insert and that the insert and the valve flap can be located in a common cylindrical area when the valve flap is in an open condition. In contrast, for example, reference numeral 210 generally indicates a duckbill valve which forms part of the prior art. Such valves clearly utilise significantly more cross-sectional flow area then the embodiments of the non-return valves 10, 60, 70, 120.

It is envisaged that the biasing mechanism described above can include pushrods to activate the valve closure from outside of the non-return valve. In other embodiments, conceivable practical means can include electromagnetic or electrical mechanisms.

In the various embodiments described above, the valve flap has a curved transverse profile. Thus, static pressure of fluid on the valve flap can be exerted substantially equally in all directions. In other words, the shape of the valve flap provides it with structural integrity thereby minimising material to be used and maintaining the valve flap suitably thin so as to minimise interference with fluid flow when the valve flap is in the open condition.

Present applications that require a foot valve or a non-return valve of some kind include liquid discharge from storm water drains into rivers or seas where reverse flow must be prevented due to changing water level that is due to tide height changes or river height changes.

A similar situation occurs when a boat's bilge pump discharges water through a pipe into the sea. Here the discharge pipe diameter must be large to evacuate as much water as possible very quickly for obvious reasons. Backflow into the pipe and backflow through the bilge pump must be prevented. Here the outlet must be low and as close to the water as possible so that the pump does not have too much height-generated head pressure to lift against. This boating application does not concern the efficiency or priming of the bilge pump but only the pipe sealing against any backflow through the pump, which could flood the boat.

Yet another situation is where water tanks are joined by pipework and are at different heights. In many cases backflow through the joining pipes must be prevented. Situations exist where flow must be only in one direction such as flooding of rice fields or other irrigation applications. In some of these situations, no pumps are employed but instead the water simply flows from a higher to a lower level. However, the source water level may change due to river height dropping or rain elevating the water level in the field to above the water source height. Here backflow must be prevented whether the flow is pump or gravity driven.

There are numerous situations in all industries including aerospace, aeronautical and automotive where fluid must flow only one direction in a channel or pipe or otherwise must be able to be re-directed into branching channels or pipes by opening or closing valves.

Existing foot valves and fluid check valves can significantly reduce cross sectional area of a pipe or cause a detrimental deviation of the fluid from straight flow through the valve. This retards the flow to a pump or to other systems, which reduces the flowrate.

Many situations require a pump to initially draw fluid, for example water, from below the level of the pump. Examples are in agriculture or rural settings where water must be lifted from a tank, dam or river or otherwise a swimming pool where the water level is below the pump.

For efficient priming of a pump all parts must function efficiently. A self-priming pump must evacuate the air within itself and in the delivery pipe so that atmospheric pressure pushes the water upwards, following the air.

If the water can be kept in the pump and in the delivery pipe back to the source, then the problem of priming may be substantially solved.

Pumps used for rural applications where water must be lifted from a dam, river or tank usually employ a conventional foot valve at the delivery pipe inlet. The weight of the water column above the conventional valve keeps it closed until the pump starts.

Most foot valves also have a spring to keep the sealing surfaces together. These foot valves are meant to keep the delivery pipe always filled up to the pump so that the pump is always primed. See the conventional foot-valve 200.

The conventional foot-valve shown has six parts. Versions of the non-return valve described herein valve have only two parts. This can reduce manufacturing cost significantly.

As can be seen in the drawings, embodiments of the non-return valve described herein can fit entirely within the delivery pipe and a reduction of a cross-sectional area is minimised.

The new valve flap, when opened, substantially conforms to the circular inside of a suction pipe or the conduit.

When the new valve flap is in the closed position it functions as an arch. Because the pressure of the water on the closed valve flap is static and is thus exerted in all directions substantially equally, the valve flap cannot easily collapse even with significant back pressure.

In various embodiments of the non-return valve described herein, the need for high precision of the mated surfaces is substantially reduced. This is as a result of the settling described above with reference to the various embodiments.

In various embodiments, the valve flap is composed or partially comprised of either natural or synthetic rubber or any material possessing rubberlike properties. As described with reference to FIGS. 43 and 44, the valve flap has a harder, less flexible, support structure 152 or “backbone” placed above, under or integral with it. Otherwise, the harder backbone may be moulded within the more flexible rubberlike material.

The support structure presses through the softer, more flexible rubberlike material to close small gaps that might otherwise have allowed the valve to leak.

The rubberlike material extends past the outer edge of the support structure. It is tough but flexible and the water pressure from above, below or combination of above and below pulls or pushes the flexible material onto the counterpart non-moving surface or valve seat to facilitate sealing.

When the various embodiments of the non-return valve are above a pump discharge, the non-return valve may allow pumps to remain primed and the suction pipe filled right back to the water source. Because of the low fabrication costs, multiple valves may be employed. The non-return valves may be placed beyond and above the pump discharge and also another non-return valve before the pump. That way even a slightly leaky version may hold the water in the pump and delivery pipe long enough to achieve almost instant priming.

In some applications this may eliminate the need to place foot valves under the water at the bottom of a suction pipe or in the inlet pipe at the bottom of a swimming pool skimmer box. The non-return valve is instead more conveniently placed above or beyond the water pump discharge including above the filter or immediately before the inlet to the pump or both.

As described above with reference to a number of the embodiments, the valve flap is capable of “settling”. For example, the valve flap of the non-return valve 10 can shift so that the valve flap can close onto the valve seat in a slightly different position each time, both slightly rotationally and slightly linearly and yet substantially always seal.

The foot valve 200 has an outside diameter of about 102 millimetres (mm) and a length of about 167 mm. Its smallest internal diameter for water passage is about 48 mm. The water undergoes a significant direction and momentum change when passing through it.

In some countries, water pipes used for agriculture, rural, pools and spas, although classed as 2 inch or 50 mm internal diameter, are actually about 54 mm internal diameter (2375.835 square mm). At its smallest internal diameter of 47.5 mm (1772 square mm), the conventional valve 200 has a cross sectional area of about 75% of the pipe cross sectional area.

In a number of embodiments of the non-return valve, the cross sectional flow area is about 2043 square mm for the same classification as the valve 200, being 86% of the pipe cross sectional area.

In the duckbill valve 210, the straight line vertical closure dictates that the circumference of the “Duck” valve, if able to be fully open would be 108 mm and so the cross sectional area would be 928 square millimetres compared to the cross sectional area of a 55 mm ID pipe which is 2375.835 square mm. It is also usually not possible for the valve 210 to present a circular cross sectional flow area because of the relatively inflexible nature valve closure. Thus, its cross sectional area is likely below 30%.

It is important to note that the laws governing flows through pipes indicate that as speed increases through the pipe the friction and therefore the resistance, increases by the square. So by having the cross sectional area of the pipe reduced to 39% by the imposition of the valve, the fluid increases its speed 2.5 times and the resistance at that point would increase 6.25 times (the inverse square law).

In addition, the momentum change is detrimental as the water must speed up and then slow down. This can result in the pump being partially starved of fluid and its output and efficiency reduced perhaps significantly.

The various embodiments of the valve insert may be attached within the pipe by any means including gluing, employing bolts or screws, flanges and bayonets to prevent it moving back with the reverse flow.

The manner in which the various embodiments of the insert is fitted is useful for retrofitting where pipe entrances may be surrounded by concrete and hence only the pipe inside wall is accessible. An example is the suction pipe inlet at the bottom of a swimming pool skimmer basket.

The non-return valve may be attached by glue that hardens and adheres only to the pipe wall but not to the rubber-like stator as shown in FIGS. 40 to 42. In this way a failed rubber stator may be removed and a new one inserted because the glue remains attached to the pipe.

The new valve may be actuated from a distance, including by pushrods through the pipe wall, by servos or by any means including hydraulic tubes or electromagnetic or electrical means. This may enable control of fluid flows by actively switching the valve opening and closing between multiple pipes.

In this way fluid flows may be directed in reverse direction to normal if required for particular applications.

The various embodiments of the non-return valve can be mounted between a pool pump lint pot and the impeller intake.

The various embodiments of the non-return valve can be mounted above the pump or beyond the pump fluid discharge at any practical distance from the pump, including before or beyond any filter. If water is beyond the filter which is beyond the pump discharge and under the valve, it will save even more electricity or fuel and allow low RPM start-up. This may allow the valve to prevent fluid return back through the pump and down the delivery pipe as the valve prevents air encroaching above the water in the pipe. This is particularly useful as it may allow the use of the new valve above the pump and not at the bottom of the supply pipe. Thus a foot-valve of any kind may not need to be placed under the water.

The various embodiments of the non-return valve may allow multiple pipes to be open coming to or going from the valve.

The various embodiments of the non-return valve may have magnets embedded in either the stator or the valve flap or the flap may be a magnet or a protected ferrous material, or both, to keep it closed in cases of low pressure backflow. In versions with rubberlike material, the rubber may be moulded to cause a slight stretching when in the open position. This may cause the valve to close quicker in cases of low back-pressure and may cause a larger closure pressure.

The various embodiments of the non-return valve may have any part of it manufactured, including by moulding, to possess a geometry that is relatively rigid but is slightly deformed when it is open. This may exert a pressure on the sealing surface when in the closed position without employing a spring or any other separate component. This may involve moulding a section of the valve closure to a slightly different shape so that when closed under this small pressure, the water pressure adds to the pressure to enable the two sealing surfaces to form a good seal.

The valve insert may be integral with a pipe joiner and thus similar to a manufactured pipe joint that joins two pipes. It may replace the usual manufactured pipe joiner being substantially the same with only the inside member being the valve insert for the non-return valve.

Thus, various embodiments of the non-return valve can possibly have a cost that is not significantly more than a commercially available pipe joiner and so the cost of that joiner can be deducted from the cost of the new valve. The valve flap or moving part of the non-return valve is potentially a very low cost item by modern injection moulding methods.

By having the pump always primed, the electricity saved can cover the cost of the non-return valve in a short time. This is because, in some applications, especially pool filtration using slow speed pump running employing variable speed motors, the pump must run at high speed for typically 2 minutes and sometimes much longer, to achieve priming before the RPM subsequently drops back to a lower speed for low cost filtration.

Not requiring this long priming run time at high speed can deliver energy cost savings in excess of the cost of the new valve.

A part may be glued to the conduit or pipe entry that may extend into the pipe. This part may be circular or only part circular and may possess a restraint for the flap anchor and may also provide a ramp, when the valve is being closed by the water pressure to force the valve upwards to press onto the “roof” of the pipe

In other versions, the insert or stator may be hard but may have a softer part held between the stator and the pipe wall so that over-moulding is not required. See FIG. 35.

Any method of manufacture is contemplated and no material is prohibited.

Where water speed is very high and the new valve needs to be very strong, mesh of either plastic strands such as nylon or metal wires may be moulded into the rubberlike material in a similar way to the construction of automobile tyres. This imparts great strength with flexibility.

The various embodiments of the non-return valve may be manufactured in any diameter for any diameter pipe.

The various embodiments of the non-return valve are intended to prevent or control the backflow of any fluids including any gases or liquids or mixtures of gases or mixtures of liquids or mixtures of gases and liquids together.

The arched property of the valve flap 132 enables the employment of a thin moveable valve flap enabling only a small percentage of the pipe cross sectional area to be reduced when it is in the opened position.

In some embodiments of the non-return valve, the valve seat and corresponding peripheral part of the valve flap can be precision manufactured to achieve a high quality seal. Otherwise, at a lower manufacturing cost, an adequate seal for the contemplated application can be achieved.

One application, where short term or even slightly leaky sealing is adequate, may be where a swimming pool or other type of pump must be re-primed. The pool pump leaf bowl has water added to cover the impeller eye so that the pump will have water in it to instantly prime. If even a slightly leaky version of the new valve is placed in the pool intake the leak is slow enough that the prime is successful.

With the various embodiments of the non-return valve, a fluid flow is not substantially deviated as with other valves and it does not force the fluid column to substantially re-shape as it passes through this new valve. This can result in enhanced efficiencies.

Retro-fitting the various embodiments of the non-return valve into the entry of the suction pipe at the bottom of a swimming pool skimmer box is facilitated in most cases as some embodiments possess the serrations 50 designed to cut into the inside of the suction pipe and grip without being glued. These are called bayonets. In other embodiments, glue will secure the insert inside the pipe.

The action of the various embodiments of the non-return valve can be entirely passive being opened by the water flow. When the flow ceases the water backflow closes the insert. In some embodiments the valve closure can be activated by push rods or any conceivable practical means including electromagnetic or electrical.

Some pumping applications require an un-primed pump to lift water but do not employ a foot valve at the bottom of the delivery pipe. That makes it difficult to lift the water. These pumps have to be manufactured incorporating a high precision labyrinth seal where the delivery pipe meets the impeller eye. These are called “self-priming” pumps. It can often take a long time for the water to rise up to these pumps, which is a waste of electricity or fuel. In addition, the height that a self-priming pump can lift water for initial priming without employing a foot-valve is limited and the pumping performance is usually intentionally compromised to get a “trade off” to achieve as much lift height as possible.

Because of the flow retardation and water direction change they impose, conventional foot valves or check valves are not ideal. They can be of large diameter and can be costly, making them unsuitable from a cost and practicality viewpoint for many applications. It is submitted that the various embodiments of the non-return valve described herein address the problems associated with such conventional foot valves or check valves for the reasons set out herein.

The appended claims are to be considered as incorporated into the above description.

Throughout the specification, including the claims, where the context permits, the term “comprising” and variants thereof such as “comprise” or “comprises” are to be interpreted as including the stated integer or integers without necessarily excluding any other integers.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

Various substantially and specifically practical and useful exemplary embodiments of the claimed subject matter, are described herein, textually and/or graphically, including the best mode, if any, known to the inventors for carrying out the claimed subject matter. Variations (e.g., modifications and/or enhancements) of one or more embodiments described herein might become apparent to those of ordinary skill in the art upon reading this application. The inventors expect skilled artisans to employ such variations as appropriate, and the inventors intend for the claimed subject matter to be practiced other than as specifically described herein. Accordingly, as permitted by law, the claimed subject matter includes and covers all equivalents of the claimed subject matter and all improvements to the claimed subject matter. Moreover, every combination of the above described elements, activities, and all possible variations thereof are encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the practice of the claimed subject matter.

Thus, regardless of the content of any portion (e.g., title, field, background, summary, description, abstract, drawing figure, etc.) of this application, unless clearly specified to the contrary, such as via explicit definition, assertion, or argument, or clearly contradicted by context, with respect to any claim, whether of this application and/or any claim of any application claiming priority hereto, and whether originally presented or otherwise:
a. there is no requirement for the inclusion of any particular described or illustrated characteristic, function, activity, or element, any particular sequence of activities, or any particular interrelationship of elements;
b. no characteristic, function, activity, or element is “essential”;
c. any elements can be integrated, segregated, and/or duplicated;
d. any activity can be repeated, any activity can be performed by multiple entities, and/or any activity can be performed in multiple jurisdictions; and
e. any activity or element can be specifically excluded, the sequence of activities can vary, and/or the interrelationship of elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Moreover, when any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

Words indicating direction or orientation, such as “front”, “rear”, “back”, etc, are used for convenience. The inventor(s) envisages that various embodiments can be used in a non-operative configuration, such as when presented for sale. Thus, such words are to be regarded as illustrative in nature, and not as restrictive. For example, the words “outer” and derivatives or synonyms thereof are used to indicate a direction or orientation radially outwardly from the valve insert of the various embodiments. The words “inner” and derivatives or synonyms thereof are used in an opposite sense. Also, the word “front” and derivatives or synonyms thereof indicates a direction or orientation that is equivalent to a direction of fluid flow through the various embodiments of the non-return valve. The words “rear” and derivatives or synonyms thereof are used in an opposite sense.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

1. A non-return valve that comprises
a cylindrical valve seat insert that defines a fluid passageway and a valve seat terminating the passageway; and
a valve closure that includes
a valve flap that is pivotal about a pivot region with respect to the valve seat between a closed condition in which a periphery of the valve flap operatively engages the valve seat to close the fluid passageway and an open condition in which fluid is permitted to flow through the passageway; and
a biasing mechanism that is interposed between the valve flap and an internal surface of the insert to bias the valve flap into the closed condition, the biasing mechanism being configured and arranged with respect to the valve flap such that a level of bias is adjusted to facilitate movement of the valve flap into the open condition.

2. The non-return valve as claimed in claim 1, in which the periphery of the valve flap and the valve seat define complementary nesting formations that nest together when the valve flap is in the closed condition such that corresponding portions of the nesting formations define the pivot region.

3. The non-return valve as claimed in claim 2, in which the nesting formation of the valve flap is in the form of a peripheral ridge that extends inwardly and the nesting formation of the valve seat is in the form of a peripheral recess in which the ridge is received when the valve flap is in the closed condition.

4. The non-return valve as claimed in claim 3, in which an outer lip extends radially inwardly from the valve seat to overhang the periphery of the valve flap when the valve flap is in the closed condition.

5. The non-return valve as claimed in claim 4, in which the outer lip is of a suitable material and is dimensioned so that the outer lip can deform as a result of backpressure upstream of the valve closure to enhance sealing of the valve flap to the valve seat.

6. The non-return valve as claimed in claim 1, in which the biasing mechanism is configured so that the biasing mechanism can be displaced both pivotally and linearly with respect to the valve flap to adjust the level of bias.

7. The non-return valve as claimed in claim 6, in which the biasing mechanism includes an elongate, resiliently extendable member that is fixed, at one end, to the internal surface of the insert, and a catch that is fixed to an inner side of the valve flap, the catch defining an outwardly directed catch surface that is inwardly spaced from the inner side of the valve flap, an opposite end of the extendable member being engaged with the catch surface so that the opposite end of the extendable member can slide along the catch surface and towards the pivot region when the valve flap moves into the open condition and along the catch surface away from the pivot region when the valve flap moves into the closed condition.

8. The non-return valve as claimed in claim 7, in which the resiliently extendable member is of an elastomeric material.

9. The non-return valve as claimed in claim 7, in which the catch includes a catch arm that is spaced from the inner side of the valve flap and extends from the pivot region towards a region diametrically opposed to the pivot region and that defines the catch surface.

10. A non-return valve that comprises
a cylindrical valve seat insert that defines a fluid passageway and a valve seat terminating the passageway, the insert including a valve closure retainer arranged on the valve seat; and
a valve closure that includes
a valve flap having an inner periphery that is operatively engageable with the valve seat; and
an anchor that is arranged on the valve flap and is anchored to the retainer so that the anchor can pivot with respect to the insert between an open condition in which the external surfaces of the insert and the valve flap are located in a common cylindrical area and a closed condition in which the valve flap bears against the valve seat; wherein
the anchor and the retainer are configured so that the anchor is constrained to a limited amount of linear movement relative to the retainer during pivotal movement between the open and closed conditions to facilitate sealing of the valve flap and the valve seat.

11. The non-return valve as claimed in claim 10, in which the anchor defines a pivot formation and the valve closure retainer defines an aperture, the anchor being dimensioned to extend through the aperture with the pivot formation located and retained at least partially externally of the valve seat.

12. The non-return valve as claimed in claim 11, in which the aperture opens externally into a recess defined by the retainer so that the pivot formation can pivot within the recess.

13. The non-return valve as claimed in claim 12, in which the retainer includes a pivot member at a front of the recess, the pivot formation being shaped so that it can hook onto and pivot about the pivot member and the recess and the pivot formation being dimensioned so that, when the valve flap is in the open condition, a gap is defined between the pivot formation and rear surfaces of the recess and the aperture to provide an extent of play of the valve closure with respect to the insert when the valve flap moves into the closed condition.

14. The non-return valve as claimed in claim 12, in which the recess is located so that an internal surface of a fluid conduit in which the valve can be mounted serves to close the recess, the extent of play being such that, when the valve closure pivots into the closed condition, the valve closure is constrained to move linearly by the internal surface of the fluid conduit such that the pivot formation moves into a position in which it is retained in the recess.

15. The non-return valve as claimed in claim 12, in which an operatively internal surface of the pivot formation and the valve flap corresponds with a portion of the valve seat so that the pivot formation can nest with the valve flap.

16. The non-return valve as claimed in claim 10, in which the valve seat includes a proximal seat face and a distal seat face that lie in respective intersecting planes with the proximal seat face transitioning to the distal seat face via a curved transition zone.

17. The non-return valve as claimed in claim 16, in which the plane of the proximal seat face and the plane of the distal seat face are symmetrical so that, in the closed condition, the valve flap is orthogonal with respect to a direction of normal fluid flow.

18. The non-return valve as claimed in claim 10, in which one of the inner periphery of the valve flap and the valve seat is chamfered or tapered to define an edge and the other of the valve flap and the valve seat is configured so that the edge can be embedded in said other of the valve flap and the valve seat.

19.-20. (canceled)

21. The non-return valve as claimed in claim 10, in which the insert defines a circumferentially extending channel, such that the channel can be filled with a settable composition or compound that is configured to adhere to the internal surface of the fluid conduit, but not to the material of the insert.

22. (canceled)

23. A non-return valve that comprises
a cylindrical valve seat insert that defines a fluid passageway and a valve seat terminating the fluid passageway, the valve seat insert defining an anchor recess;
a valve closure that includes
a valve flap having an external profile that corresponds with that of the insert;
a flexible hinge that is arranged on the valve flap; and
an anchor that is arranged on the flexible hinge so that the flexible hinge interconnects the anchor and the valve flap, the anchor and the anchor recess being dimensioned so that the anchor can be positioned in the anchor recess and retained in the anchor recess against movement in a direction of fluid flow; wherein
the anchor recess is positioned so that when the insert is secured within a conduit, an internal surface of the conduit partially closes the recess to define a chamber or volume in which the anchor is located and so that the valve flap can pivot between an open condition in which the external surfaces of the insert and the valve flap are located in a common cylindrical area and a closed condition in which the valve flap bears against the valve seat.
